(19) United States
(12) Patent Application Publication
(10) Pub. No.: US 2022/0036291 A1
(43) Pub. Date: Feb. 3, 2022

(54) HANDLING METHOD OF A TRANSPORT EQUIPMENT SET AND TRANSPORT EQUIPMENT SET

(71) Applicants: Chongqing HKC Optoelectronics Technology Co., Ltd., Chongqing (CN); HKC Corporation Limited, Shenzhen (CN)

(72) Inventors: Tiaohong WANG, Chongqing (CN); Chongwei TANG, Chongqing (CN)

(21) Appl. No.: 17/210,542

(22) Filed: Mar. 24, 2021

(30) Foreign Application Priority Data
Jul. 30, 2020 (CN) 202010752769.4

(51) Int. Cl. G06Q 10/08; B65G 1/137

(52) U.S. Cl. CPC G06Q 10/087; B65G 1/1371

(57) ABSTRACT

This application discloses a handling method of a transport equipment set, the transport equipment set including an exclusive transport storage section; an intermediate storage section; and an automatic warehousing device operative to move within the range of the exclusive transport storage section and the intermediate storage section. The handling method of the transport equipment set includes: obtaining a current instruction executed by the automatic warehousing device; and determining whether it conflicts with the automatic warehousing device and so needs to skip the current instruction and turn to execute a next instruction.

The present application claims priority to Chinese Patent Application No. 202010752769.4, filed Jul. 30, 2020, which is hereby incorporated by reference herein as if set forth in its entirety.

### TECHNICAL FIELD

This application relates to the field of display technology, and more particularly relates to a handling method of a transport equipment set and transport equipment set.

### BACKGROUND

The statements herein merely provide background information related to the present application but don't necessarily constitute the prior art.

Nowadays, in a TFT-LCD (Thin-film-transistor liquid-crystal display) factory, the automated warehousing of liquid crystal panels, especially glass substrates, plays an important role in the management and control of the entire factory's material flow, and the realization of the entire factory's automated management and control requires the judgment logic of a software system. A stocker schedule system (SSS), which is an automatic warehousing device control system, is one such important system. The main function served by SSS is using the operation information of an automatic warehousing device to manage the relevant control hardware and information flow within the automatic warehousing device. Currently, SSS can achieve the standard of effectively managing the transportation and storage of an automatic material flow system, but it still needs further optimization. In order to meet the market's demand for LCD panels, factories require even more efficient warehousing automation. Many factories use multiple automatic warehousing devices (cranes) to operate in the same storage section, and set up an intermediate storage section (handoff) for each automatic warehousing device (crane) to avoid interference with the work performance thus improving the efficiency of the automatic material flow. However, when one automatic warehousing device (crane) first executes a To/From-Handoff instruction (meaning storage to or taking out from the intermediate storage section), while another automatic warehousing device (crane) also needs to execute the To/From-Handoff instruction at the same time, the other automatic warehousing device (crane) would have to wait at a safe distance for the completion of execution of the previous automatic warehousing device (crane) before it can execute its own instruction.

### SUMMARY

This application provides a handling method of a transport equipment set and an operating method of an automatic warehousing device, which reduce the waiting time and improve the transportation capacity.

This application discloses a handling method of a transport equipment set, where the transport equipment set includes at least two exclusive transport storage sections configured for storing cassettes, an intermediate storage section disposed between the two adjacent exclusive transport storage sections, and an automatic warehousing device that is configured for transporting the cassettes and that is operative to move within the range of the corresponding exclusive transport storage section and the adjacent intermediate storage section. The handling method of a transport equipment set includes the following operations. A current instruction executed by the automatic warehousing device is obtained. If the current instruction is a first instruction, a determination is made as to whether the automatic warehousing device conflicts with another neighboring automatic warehousing device during execution. If it is determined that the automatic warehousing device conflicts with the other neighboring automatic warehousing device during execution, the automatic warehousing device may skip the current instruction and turn to execute a second instruction. If the automatic warehousing device does not conflict with the other neighboring automatic warehousing device during execution, then the automatic warehousing device may execute the current instruction. In the above description, the first instruction is a handling instruction of the automatic warehousing device involving the intermediate storage section, and the second instruction is a handling instruction of the automatic warehousing device according to which the automatic. warehousing device does not need to pass through the intermediate storage section, and winch only needs to be executed by the automatic warehousing device in the corresponding exclusive transport storage section.

According to this application, when two automatic warehousing devices are both executing the handling instruction that needs to cross the intermediate storage section (handoff) at the same time, the current automatic warehousing device may detect the movement of the other automatic warehousing device during execution. If the movement of the other automatic warehousing device is in conflict with the path executed by the current automatic warehousing device, then the current automatic warehousing device may skip this instruction and turn to directly execute a next instruction. This reduces the waiting time, speeds up the efficiency of completion of instructions, improves the transport efficiency, and effectively reduces the waiting time during the manufacturing of the products.

### BRIEF DESCRIPTION OF DRAWINGS

The drawings included herein are intended to provide a further understanding of the embodiments of the present application. They constitute a part of the specification, and are used to illustrate the embodiments of the present application, and explain the principle of the present application in conjunction with the specification. Apparently, the drawings in the following description merely represent some embodiments of the present disclosure, and for those having ordinary skill in the art, other drawings may also be obtained based on these drawings without investing creative efforts.

In the drawings:

FIG. 1 shows a schematic diagram illustrating a transport equipment set according to this application.

FIG. 2 is a flowchart illustrating a handling method of a transport equipment set according to this application.

FIG. 3 is a schematic diagram illustrating the operations a handling method of a transport equipment set according to this application.

FIG. 4 shows a flowchart illustrating the operation of a handling method of a transport equipment set according to this application.

FIG. 5 shows a schematic diagram illustrating a transport equipment set according to this application.

### DETAILED DESCRIPTION OF EMBODIMENTS

It will be appreciated that the terminology used, and the specific structure and function details disclosed herein are intended for mere purposes of illustrating specific embodiments and are representative. This application, however, maybe implemented in many alternative forms and thus is not be construed as being limited to the embodiments set forth herein. As used herein, terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features. Terms “multiple” or “a plurality of” means two or more. Terms “including”, “comprising”, and any variations thereof are intended for non-exclusive inclusion, meaning that there may exist or may be added one or more other features, integers, steps, operations, units, components, and or combinations thereof. In addition, terms “center”, “transverse”, “up”, “down”, “left”, “right”, “vertical”, “horizontal”, “top”, “bottom”, “inside”, “outside”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms should not be construed as restricting the present disclosure. Furthermore, terms “installed on”, “mounted on”, “connected to”, “coupled to”, “connected with”, and “coupled with” should be understood in a. broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood on a case-by-case basis. Hereinafter, this application will be described in further detail in connection with the drawings and some illustrative embodiments.

The transport equipment set and the handling method of the transport equipment set described in this application are intended for the storage of display panels, including but not limited to liquid crystal display panels, organic electroluminescent (organic EL) diode display panels, etc. The items to be handled are usually cassettes loaded with display panels. For the time being, the warehousing of liquid crystal display panels mostly uses two automatic warehousing devices, and a small part uses one automatic warehousing device. The following embodiments and drawings will all use two automatic warehousing devices in operation as an example.

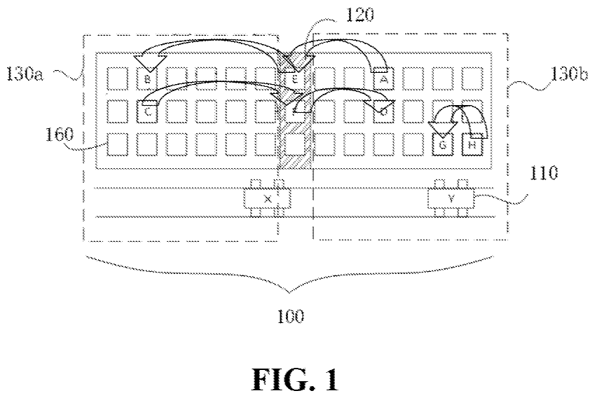

Referring to FIG. 1, this application discloses a handling method of a transport equipment set. The transport equipment set 100 includes at least two automatic warehousing devices 110, an exclusive transport storage section 130 set up corresponding to each automatic warehousing device 110, and an intermediate storage section 120 disposed between the two adjacent exclusive transport storage sections 130.

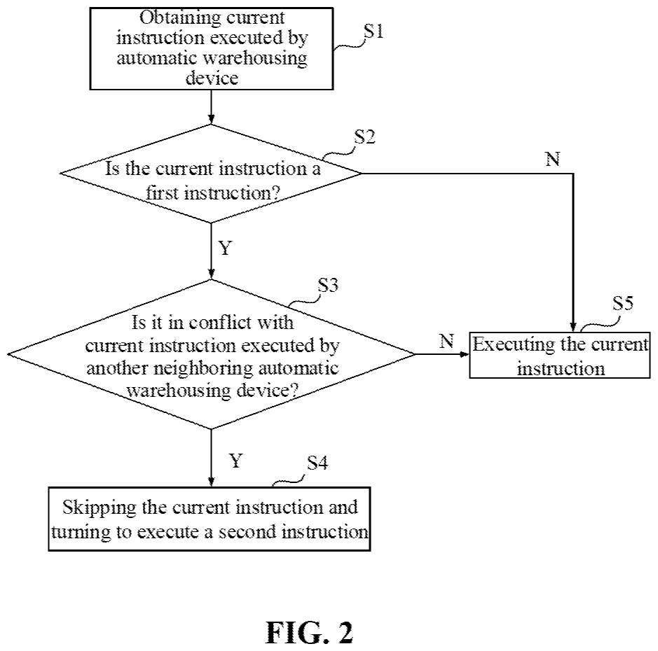

Referring now to FIGS. 1 and 2, the handling method of the transport equipment set may include the following operations: S1, obtaining a current instruction executed by the automatic warehousing device; S2, if the current instruction is a first instruction, performing S3; if the current instruction is a second instruction, performing S5; S3, determining whether the automatic warehousing device conflicts with another neighboring automatic warehousing device during execution, and performing S4 if the automatic warehousing device conflicts with the other neighboring automatic warehousing device diming execution, otherwise performing S5; S4, the automatic warehousing device skipping the current instruction, and turning to execute a second instruction; S5, the automatic warehousing device executing the current instruction. In the above description, the first instruction is a handling instruction of the automatic warehousing device 110 involving the intermediate storage section 120, and the second instruction is a handling instruction of the automatic warehousing device 110 according to which the automatic warehousing device 110 does not need to pass through the intermediate storage section 120, and which only needs to be executed by the automatic warehousing device 110 in the corresponding exclusive transport storage section. Let's assume that two neighboring automatic warehousing devices 110 are X and Y, the first exclusive transport storage section 130a is the exclusive transport storage section of X, and the second exclusive transport storage section 130b is the exclusive transport storage section of Y. Each of the exclusive transport storage sections 130 and the intermediate storage sections 120 may include a plurality of storage spots. The current instruction of X is a first instruction of transporting from the storage spot E in the first exclusive transport storage section 130a to the storage spot B in the intermediate storage section 120. Because it is detected that Y is not in the intermediate storage section 120, X executes the first instruction of transporting from storage spot E is to storage spot B. If Y is ready to execute the task of F->D, namely transporting from the storage spot F in the intermediate storage section 120 to the storage spot D5 in the second exclusive transport storage section 130b, then because before execution it is detected that the warehousing device X is already executing the first instruction (E->B), the warehousing device Y would skip the current F->D instruction and turn to execute the next second instruction H->G. Both the above B-E and F-D are instructions of taking out from the intermediate storage section (From handoff), while C-F and A-E are instructions of storing to the intermediate storage section (To handoff). By way of example, this application uses the instruction of taking out from the intermediate storage section (From handoff) as the first instruction, which is also applicable to the cases where the first instruction is the instruction of storing to the intermediate storage section (To handoff). When the automatic warehousing device is to execute the second instruction, because the second instruction does not pass through the intermediate storage section 120 shared by the two automatic warehousing devices, there is no need for detection and this automatic warehousing device may directly execute the current instruction. In contrast, when the current automatic warehousing device 110 is to execute the first instruction, it may detect the movement of the other automatic warehousing device, and if the other automatic warehousing device is in conflict with the path executed by the current automatic warehousing device, then the current automatic warehousing device may skip this instruction and turn to execute a next instruction. Compared with the case of waiting until the other automatic warehousing device leaves before executing the instruction, this reduces the waiting time and speeds up the completion of the instruction. Each automatic warehousing device 110 has and only one exclusive transport storage section 130. Assuming that the automatic warehousing devices have a clear division of labor and are filly coordinated, which reduces the ineffective distance traveled by the automatic warehousing devices, improves the transportation efficiency, saves costs, and makes the entire warehousing system operate efficiently and orderly thus facilitating the manufacturing process of display panels.

When the instruction to be executed is only in the exclusive transport storage section 130, namely the second instruction, because there is no need to pass through the intermediate storage section 120, there will be no conflict with the other automatic warehousing device 110; that is, this instruction may be executed directly without detection. Multiple automatic warehousing devices 110 may also execute the second instruction at the same time, and carry out the handling operation in their respective exclusive working storage sections 130, which not only saves time, but also reduces the number of detections on other automatic warehousing, devices that are performed by the current automatic warehousing device, thus greatly reducing the system's power consumption.

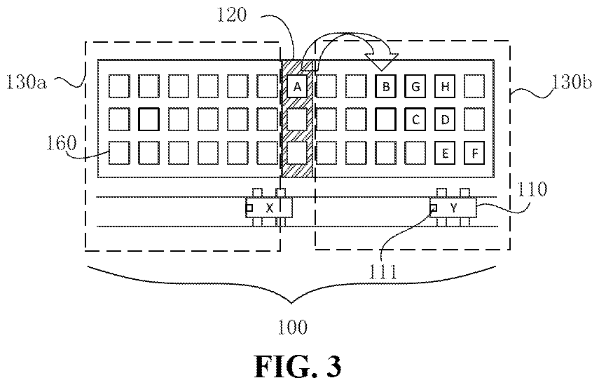

Referring, now to FIG. 3, each automatic warehousing device 110 may include a communication means 111. The automatic warehousing device 110 may determine whether it conflicts with another neighboring automatic warehousing device using the communication means 111. Each automatic warehousing device 110 is equipped with a communication means 111 to detect and communicate with one another in real time its working status and the safety distance between the automatic warehousing devices 110, thus avoid collisions that may happen in the process of executing instructions, and monitoring in real time the working status of automatic warehousing devices to also avoid the occurrence of sudden collisions or emergency stops after a period of time of execution.

Based on the communication means 111, there may be multiple ways to determine whether there will be a conflict between the automatic warehousing devices 110. Illustration is provided below through examples.

For example, the automatic warehousing device Y may monitor using the communication means 111 whether the current instruction executed by the other neighboring automatic warehousing device X is the first instruction, and then determines whether there is a conflict.

In particular, if the current instruction executed by other automatic warehousing device X is also the first instruction, it means that two automatic warehousing devices both need to pass through the intermediate storage section 120 between the two at the same time. Thus, it may be determined that the automatic warehousing device Y conflicts with the automatic warehousing device X, and accordingly, Y may skip the current first instruction and turn to execute a next instruction.

Otherwise if the automatic warehousing device detects through the communication means 111 that the current instruction executed by the other neighboring automatic warehousing device is not the first instruction, then it may be determined that the current automatic warehousing device conflicts with the other automatic warehousing device, and the automatic warehousing device may directly execute the current instruction.

It is also possible to determine whether there is a conflict between the automatic warehousing device and another neighboring automatic warehousing device by reading the relative positions using the communication means 111 without reading instructions. If the relative positions are lower than the preset value, then it may be determined there is a conflict with the other neighboring automatic warehousing device. The preset value may be set to the width of the intermediate storage section. If the distance between the relative positions of two automatic warehousing devices is less than the width of the intermediate storage section, then it may be determined that one of the automatic warehousing devices is executing the first instruction, and so the other automatic warehousing device may skip executing the current instruction and turn to execute a next instruction, where the next instruction is the second instruction. In addition to setting a preset value, the communication device may also set a safe distance to avoid collisions between two automatic warehousing devices. The safety distance may be set to the width of an automatic warehousing device. If the distance between two automatic warehousing devices is less than the width of one automatic warehousing device, it means that there is another automatic warehousing device 110 present within the safe distance. If two automatic warehousing devices 110 are too close to each other, they may collide onto each other. The safety distance may also be set quantitatively based on the area of the automatic warehousing factory, the large working range of an automatic warehousing device, and other factors. When the distance between two neighboring automatic warehousing devices is less than the safety distance, one of the automatic warehousing devices may be controlled to suspend the execution of the current instruction, and wait until the other automatic warehousing device has finished executing its current instruction and the distance is greater than or equal to the safety distance, before continuing to executing corresponding current instruction.

Of course, it is also possible to determine whether there will be a conflict between two neighboring automatic warehousing devices 110 based on the absolute positions of the automatic warehousing devices and the intermediate storage section. In particular, a detection alarm may be set up at the intermediate storage section 120. When any automatic warehousing device enters the intermediate storage section 120, the detection alarm may inform another automatic warehousing device, and the other automatic warehousing device would determine whether there is a conflict based on the current instruction to be executed. Because two automatic warehousing devices 110 are both moving under the working state, there will be a certain lag in reading the relative positions through mutual communication. Thus, when the two automatic warehousing devices 110 are moving toward each other at relatively fast speeds, the actual relative positions will be smaller than the read relative positions, and so the risk of conflict between the two automatic warehousing devices 110 may still exist. The communication means may use a wired communication circuit or a wireless communication circuit. Wired communication circuits include but are not limited to circuits such as wire carriers or carrier frequencies, coaxial lines, switch signal lines, RS232 serial ports, and RS485 buses, and wireless communication circuits include but not limited to circuits such as Bluetooth, WIFI, mobile communication, and Zigbee.

Each automatic warehousing device 110 has one and only one exclusive transport storage section 130. Multiple automatic warehousing devices 110 may execute the second instruction at the same time.

The handling method may hinter include the following operation after the automatic warehousing device skips executing the current instruction and tums to execute the second instruction:

continuing to execute the first instruction that is skipped for execution.

After completing the next instruction, the automatic warehousing device 110 may again prepare to continue to execute the skipped first instruction, in the condition that no conflict with other automatic warehousing devices during the execution of the first instruction is detected. The automatic warehousing device will execute the first instruction that was skipped before. That is, after step S4 is performed, step S2 may he repeatedly performed to complete the skipped instruction. After each time of performing step S4, the automatic warehousing device may immediately return to the previous node to get ready to complete the execution of the uncompleted instruction, making it not easy to cause omissions of the instructions that may otherwise cause multiple subsequent instructions to result in operational errors in the handling and placement order due to the negligence of one instruction. As illustrated in FIG. 3, for example, the skipped instruction is transporting from A in intermediate storage section 120 to storage spot B, and the current automatic warehousing device has completed the execution of the next instruction, C-D. At this point, according to the original order, the instruction E-B should he executed. But the originally set instruction is actually earlier than E-B, and so there should have been a cassette 1 on storage spot B. The E-B instruction is to transfer the cassette 2 at storage spot E onto the existing cassette 1 that is already on storage spot B. However, because the instruction A-B is skipped earlier, the position on which cassette 2 of E-B will be changed, affecting the order and configuration in which the cassettes in storage spot 160 are placed.

As a result, the structure may become unstable and so the display panels in cassette 2 may very likely drop and he damaged. Therefore, after completing the next instruction C-D, the automatic warehousing device may continue to prepare to execute the instruction A-B, thereby preventing the mistake in placing the cassettes from causing the structural instability of multiple cassettes loaded in the storage spot 160.

More particularly, if the automatic warehousing device detects that it still conflicts with other neighboring automatic warehousing devices during execution, then the automatic warehousing device may repeatedly perform operation S4 until there is no skipped instruction in the remaining uncompleted instructions of the automatic warehousing device.

As another embodiment of the present application, the operation that the automatic warehousing device skips the current instruction and turns to execute the next instruction may also comprise continuing to execute the remaining uncompleted instructions in the order of priority of the instructions, where the first instruction has a higher priority than the second instruction.

In particular, the automatic warehousing device may further include an automatic warehousing device control system 170, which is used to produce instructions and to prioritize the instructions. When the automatic warehousing device skips the current instruction and completes the next instruction, the automatic warehousing device control system 170 included in the automatic warehousing device may re-prioritize the remaining uncompleted instructions after each automatic warehousing device finishes executing an instruction. After the automatic warehousing device performs operation S4, the automatic warehousing device control system 170 may provide new instructions and so the automatic warehousing device may continue to execute the remaining instructions according to the priority order of these instructions.

Rearranging the priority order of the uncompleted instructions each time may better realize the warehousing function, making it not easy to cause confusion in the order of priority of the instructions because of step S4, which may otherwise cause inconvenience to the execution of subsequent instructions. As illustrated in FIG. 3, assuming that the current instruction executed by automatic warehousing device Y is A-B, namely to move a cassette from storage spot A to storage spot B, and the instructions to be subsequently executed are C-D, E-F, and G-H. When Y detects a conflict with X, Y skips the current instruction A-B and turns to execute the next instruction C-D. After executing the next instruction C-D, if Y directly returns to the previous instruction and execute the instructions in the original order, namely in the order of execution A-B, E-F, and G-H, then it will be found that the distance of travel of Y is significantly increased resulting in reduced handling efficiency. If the priorities are re-ordered after the next instruction C-D is executed, and the order of execution is adjusted to E-F, A-B, G-H, then the distance of travel of Y will be significantly reduced, thus greatly improving the handling efficiency. Therefore, whenever the automatic warehousing device skips an instruction and finishes executing the next instruction, the automatic warehousing control system may reorder the remaining uncompleted instructions, and the automatic warehousing device will execute the instructions according to the rearranged priority order, which can avoid the above problems while reducing the waiting time and improving the handling efficiency.

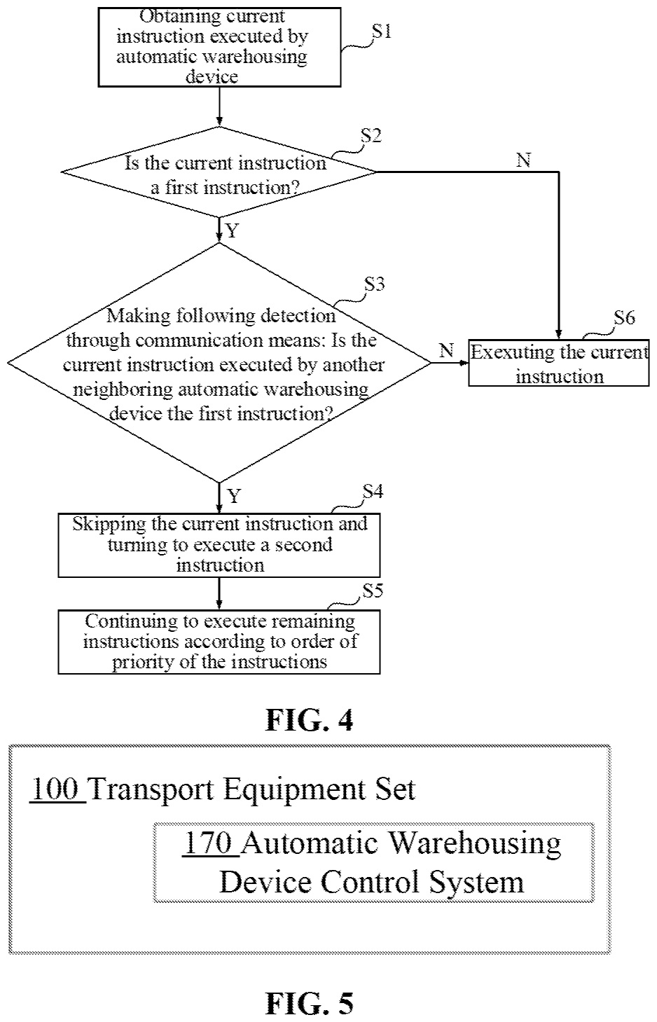

Referring to FIGS. 3 and 4, this application further discloses a handling method of a transport equipment set. The transport equipment set 100 includes at least two automatic warehousing devices 110, an exclusive transport storage section 130 set up corresponding to each automatic warehousing device 110, and an intermediate storage section 120 disposed between the two adjacent exclusive transport storage sections 130. The transport equipment set 110 includes a communication means 111.

The operating method of the transport equipment set 100 may include the following operations. The handling method of the transport equipment set 100 may include the following operations: S1, obtaining the current instruction executed by the automatic warehousing device; S2, if the current instruction is a first instruction, performing S3; if the current instruction is a second instruction, performing S6; S3, the automatic warehousing device detecting through the communication means whether the current instruction executed by another automatic warehousing device is the first instruction, and performing S4 if the current instruction executed by the other automatic warehousing device is the first instruction, otherwise performing S6; S4, the automatic warehousing device skipping the current instruction, and turning to execute the next instruction, the next instruction being a second instruction; S5, the automatic warehousing device continuing to execute the remaining uncompleted instructions according to the priority order of the instructions; S6, the automatic warehousing device executing the current instruction. In the above description, the first instruction is an instruction of the automatic warehousing device 110 involving passing through the intermediate storage section 120, and the second instruction is an instruction of the automatic warehousing device 110 according to which the automatic warehousing device 110 does not need to pass through the intermediate storage section 120, and which only needs to be executed by the automatic warehousing device 110 in the corresponding exclusive transport storage section 130.

As illustrated in FIG. 5, this application further provides a transport equipment set, which includes an automatic warehousing device control system 170, which are used to perform any of the above-mentioned operating methods of transport equipment set. It should be noted that the various steps defined in this solution are not to be construed as limiting the order in which these steps are performed, on the premise of not affecting the implementation of the specific solution. In other words, the steps written earlier may be performed first, or may also be performed later, or may even be performed simultaneously. As long as the solution is able to be implemented, they variations shall all be regarded as falling in the scope of protection of this application. The technical solutions of the present application can be widely used to manage the transporting and warehousing equipment of an automatic material flow system.

The foregoing is merely a further detailed description of the present application in connection with some specific illustrative implementations, and it is to be construed as limiting the implementation of the present application to these implementations. For those having ordinary skill in the technical field to which this application pertains, numerous simple deductions or substitutions may he made without departing from the concept of this application, which shall all be regarded as falling in the scope of protection of this application.

What is claimed is:

1. A handling method of a transport equipment set, the transport equipment set comprising:
two or more exclusive transport storage sections, configured for storing cassettes;
an intermediate storage section, disposed between two adjacent exclusive transport storage sections; and
an automatic warehousing device, configured to transport the cassettes and operative to move within the range of the corresponding exclusive transport storage section and the adjacent intermediate storage section;
wherein the handling method comprises:
obtaining a current instruction executed by the automatic warehousing device;
if the current instruction is a first instruction, determining whether the automatic warehousing device conflicts with another neighboring automatic warehousing device during execution; if the automatic warehousing device conflicts with the other neighboring automatic warehousing device during execution, skipping the current instruction and turning to execute a second instruction by the automatic warehousing device; otherwise if the automatic warehousing device does not conflict with the other neighboring automatic warehousing device during execution, executing the current instruction by the automatic warehousing device; and
if the current instruction is the second instruction, executing the current instruction by the automatic warehousing device;
wherein the first instruction is a handling instruction of the automatic warehousing device involving the intermediate storage section, and the second instruction is a handling instruction of the automatic warehousing device according to which the automatic warehousing device does not need to pass through the intermediate storage section, and which only needs to be executed by the automatic warehousing device in the corresponding exclusive transport storage section.

2. The handling method of claim 1, wherein each automatic warehousing device comprises a communication means, and the automatic warehousing device is configured to determine whether it conflicts with the other neighboring automatic warehousing device through the communication means.

3. The handling method of claim 2, wherein the automatic warehousing device is configured to monitor through the communication means whether the current instruction executed by the other neighboring automatic warehousing device is the first instruction, and determine that it conflicts with the other neighboring automatic warehousing device if the current instruction executed by the other neighboring automatic warehousing device is the first instruction.

4. The handling method of claim 2, wherein the automatic warehousing device is configured to monitor relative positions between the automatic warehousing device and the other neighboring automatic warehousing device through the communication means, and determine that it is conflict with the other neighboring automatic warehousing device if the relative positions are lower than a preset value.

5. The handling method of claim 2, wherein each automatic warehousing device is provided with the communication means, each automatic warehousing device is configured to detect and communicate in real time a working status and a safety distance with one another, wherein the safety distance is set to a width of one automatic warehousing device, wherein when a distance between two neighboring automatic warehousing devices is less than the safety distance, one of the automatic warehousing devices is controlled to suspend the execution of the current instruction, and wait until the other automatic warehousing device finishes executing its current instruction and the distance is greater than or equal to the safety distance before the automatic warehousing device continues to execute the corresponding current instruction.

6. The handling method of claim 1, wherein within a preset time range, one of the two neighboring automatic warehousing devices only executes the second instruction.

7. The handling method of claim 1, further comprising the following operation subsequent to the automatic warehousing device skipping the current instruction and turning to execute the second instruction:
continuing to execute the skipped first instruction.

8. The handling method of claim 1, further comprising the following operation subsequent to the automatic warehousing device skipping the first instruction and turning to execute the second instruction:
continuing to execute, by the automatic warehousing device, remaining uncompleted instructions according to an order of priority of the instructions, wherein the first instruction has a higher priority than the second instruction.

9. The handling method of claim 8, wherein the transport equipment set comprises an automatic warehousing device control system configured to generate an instruction and deliver them to each automatic warehousing device, wherein after the automatic warehousing device skips the first instruction and executes the second instruction, the automatic warehousing device control system is configured to re-prioritize the remaining uncompleted instructions.

10. The handling method of claim 1, wherein absolute positions of the automatic warehousing device and the intermediate storage section are used to determine whether the two neighboring automatic warehousing devices are in a conflict.

11. The handling method of claim 1, wherein the intermediate storage section is provided with a detection alarm, wherein when any automatic warehousing device enters the intermediate storage section, the detection alarm is configured to notify the other automatic warehousing device, and the other automatic warehousing device is configured to determine whether there is a conflict based on the current instruction to be executed.

12. The handling method of claim 2, wherein the communication means adopts a wired communication circuit or a wireless communication circuit.

13. A handling method of a transport equipment set, the transport equipment set comprising:
two or more exclusive transport storage sections, configured for storing cassettes;
an intermediate storage section, disposed between two adjacent exclusive transport storage sections;
an automatic warehousing device, configured to transport the cassettes and operative to move within the range of the corresponding exclusive transport storage section and the adjacent intermediate storage section;
wherein the automatic warehousing device comprises a communication means;
wherein the intermediate storage section is a common transport storage section shared by two automatic warehousing devices, the exclusive transport storage section is set corresponding to each automatic warehousing device, and is arranged adjacent to the intermediate storage section;
wherein the handling method comprises:
obtaining a current instruction executed by the automatic warehousing device;
if the current instruction is a first instruction, detecting, by the automatic warehousing device through the communication means, whether a current instruction executed by another neighboring automatic warehousing device is the first instruction, and if the current instruction executed by the other neighboring automatic warehousing device is the first instruction, executing a second instruction and continuing to execute remaining instructions according to a priority order of instructions;
if the current instruction is the second instruction, executing the current instruction by the automatic warehousing device;
wherein the first instruction is a handling instruction of the automatic warehousing device involving the intermediate storage section, and the second instruction is a handling instruction of the automatic warehousing device according to which the automatic warehousing device does not need to pass through the intermediate storage section, and which only needs to be executed by the automatic warehousing device in the corresponding exclusive transport storage section.

14. A transport equipment set, comprising:
two or more exclusive transport storage sections, configured for storing cassettes;
an intermediate storage section, disposed between two adjacent exclusive transport storage sections;
an automatic warehousing device, configured to transport the cassettes and operative to move within the range of the corresponding exclusive transport storage section and the adjacent intermediate storage section;
an automatic warehousing device control system, configured to control the automatic warehousing device to transport the cassettes;
wherein the intermediate storage section is disposed between two adjacent exclusive transport storage sections, and the automatic warehousing device is operative to move within the range of the corresponding exclusive transport storage section and the adjacent intermediate storage section;
wherein the automatic warehousing device control system is configured to obtain a current instruction executed by the automatic warehousing device, and if the current instruction is a first instruction, determine whether the automatic warehousing device conflicts with another neighboring automatic warehousing device during execution; wherein if the automatic warehousing device conflicts with the other neighboring automatic warehousing device during execution, the automatic warehousing device skips the current instruction and turns to execute a second instruction; otherwise if the automatic warehousing device does not conflict with the other neighboring automatic warehousing device during execution, the automatic warehousing device executes the current instruction; and
if the current instruction is the second instruction, the automatic warehousing device executes the current instruction;
wherein the first instruction is a handling instruction of the automatic warehousing device involving the intermediate storage section, and the second instruction is a handling instruction of the automatic warehousing device according to which the automatic warehousing device does not need to pass through the intermediate storage section, and which only needs to be executed by the automatic warehousing device in the corresponding exclusive transport storage section.

15. The transport equipment set of claim 14, wherein each automatic warehousing device comprises a communication means and is configured to determine whether it conflicts with the other neighboring automatic warehousing device through the communication means;
wherein the automatic warehousing device is configured to monitor through the communication means whether the current instruction executed by the other neighboring automatic warehousing device is the first instruction, and determine that it conflicts with the other neighboring automatic warehousing device if the current instruction executed by the other neighboring automatic warehousing device is the first instruction.

16. The transport equipment set of claim 14, wherein each automatic warehousing device comprises a communication means and is configured to monitor relative positions between the automatic warehousing device and the other neighboring automatic warehousing device through the communication means, and determine that it is in conflict with the other neighboring automatic warehousing device if the relative positions are lower than a preset value.

17. The transport equipment set of claim 16, wherein the preset value is set to a width of the intermediate storage section, wherein if the distance between the relative positions of two automatic warehousing devices is less than the width of the intermediate storage section, it is determined that one of the automatic warehousing devices is executing the first instruction, and so the other automatic warehousing device skips the current instruction and turns to execute a next instruction, the next instruction being the second instruction.

18. The transport equipment set of claim 14, wherein within a preset time range, one of two neighboring automatic warehousing devices only executes the second instruction.

19. The transport equipment set of claim 14, wherein each automatic warehousing device has one and only one exclusive transport storage section.
